(19) United States
(12) Patent Application Publication
(10) Pub. No.: US 2018/0326698 A1
(43) Pub. Date: Nov. 15, 2018

(54) IMPACT RESISTANT FLEXIBLE MATERIALS, ARTICLES COMPRISING SAME AND USES THEREOF

(71) Applicant: FMS ENTERPRISES MIGUN LTD., Petach Tikva (IL)

(72) Inventor: Shalom GEVA, Holon (IL)

(21) Appl. No.: 15/775,979

(22) PCT Filed: Nov. 13, 2016
(86) PCT No.: PCT/IL2016/051222

§ 371 Date: May 14, 2018

Related U.S. Application Data
(60) Provisional application No. 62/255,463, filed on Nov. 15, 2015.

(51) Int. Cl. B32B 5/12; B32B 27/34; B32B 5/26; B32B 7/04

(52) U.S. Cl. CPC B32B 5/12; B32B 27/34; B32B 3/085; B32B 7/045; B32B 5/26

(57) ABSTRACT

The present invention relates to impact resistant flexible material, comprising a bilayered fabric comprising two adjacent unidirectional monolayers each comprising polymer fibers, with the direction of each unidirectional monolayer being rotated at an angle with respect to the direction in the other unidirectional monolayer; and at least one unidirectional spacer comprising polymer fibers, said spacer is attached to an external surface of one of said unidirectional monolayers and is covering a portion thereof.

### FIELD OF THE INVENTION

The present invention relates to impact resistant flexible material, comprising a bilayered fabric comprising two adjacent unidirectional monolayers each comprising polymer fibers, with the direction of each unidirectional monolayer being rotated at an angle with respect to the direction in the other unidirectional monolayer; and at least one unidirectional spacer comprising polymer fibers, said spacer is attached to an external surface of one of said unidirectional monolayers and is covering a portion thereof.

### BACKGROUND OF THE INVENTION

Various forms of safety garments have been created for daily use for improving wearer safety and even for extreme sport activities. Typically, many of these garments incorporate impact absorbing/resistance areas. Traditionally one of the materials for these safety garments has been thick leather. Newer materials, such as, ballistic resistant polymeric articles, replace the traditional materials or being incorporated within otherwise traditionally constructed cloth garments in order to increase their resistance.

U.S. Pat. No. 5,918,309 discloses a protective garment of multi-component construction having a layer of body armor material containing at least one of ballistic resistant and puncture resistant capabilities. Additionally, the protective garment includes a flexible sheet formed of a plurality of resilient honeycomb cellular structures which are constructed of thermoplastic polyurethane.

A ballistic resistant article constructed of high performance fibers and thermoplastic films, which is devoid of resins, is disclosed in U.S. Pat. No. 5,935,678.

U.S. Pat. No. 5,514,457 discloses textile structures, such as fabrics, knits, warp-knitted fabrics, stitch-bonded fabrics, thread structures, etc. for use in clothing which protects against stabbing, cutting, fragments and bullets, produced from wrapped yarns. The yarns have a core of penetration resistant fibers and an outer sheath of natural and/or manmade fibers that can easily be dyed, printed, or optically brightened.

U.S. Pat. No. 8,920,909 discloses anti-ballistic articles comprising a stack of sheets, each sheet having one or more mono-layers of polyethylene anti-ballistic fibers and a thermoplastic binder, wherein the specific energy absorption (SEA) of the anti-ballistic article is greater than 145 J/kg/m² and the maximum % thickness increase, measured at about 90° C., is less than 8% after storing the article for 160 hours at 90° C.

U.S. Pat. No. 8,617,680 discloses polyethylene material having a plurality of unidirectionally oriented polyethylene monolayers cross-plied and compressed at an angle to one another, each polyethylene monolayer composed of ultra-high molecular weight polyethylene and essentially devoid of resins. Further disclosed are ballistic resistant articles, containing the unidirectional polyethylene monolayers, which are resistant to stabbing with knives or other sharp elements.

EP 768,507 discloses a ballistic-resistant article containing a compressed stack of monolayers made of unidirectionally oriented reinforcing aramid fibers and a matrix consisting of a polymer, the content of which is at most 25 wt %, the fiber direction in each monolayer being rotated with respect to the fiber direction in an adjacent monolayer.

Despite the foregoing materials and processes, there still remains a need for polymeric materials having enhanced impact resistance properties, yet are comfortable to wear, being soft, flexible and light.

### SUMMARY OF THE INVENTION

The present invention relates to an impact resistant flexible material and articles containing same, which are extremely comfortable, due to their airy, flexible and soft nature.

As detailed below, the impact resistant flexible articles of the invention display unexpected flexibility and improved resistance towards various forms of impact, including stabbing and puncturing. As exemplified hereinbelow, the impact resistant flexible articles disclosed herein meet levels 1 through 3 of the NIJ 0115.00 US standard as well as other international standards for knife and spike performance.

In some embodiments, there is provided an impact resistant flexible material, comprising
a bilayered fabric comprising two adjacent unidirectional monolayers each comprising polymer fibers, with the direction of each unidirectional monolayer being rotated at an angle with respect to the direction in the other unidirectional monolayer; and
at least one unidirectional spacer comprising polymer fibers, said spacer is attached to an external surface of one of said unidirectional monolayers and is covering a portion thereof.

In some embodiments, the direction of each unidirectional monolayer is rotated with respect to the direction in the other unidirectional monolayer at an angle between 20 to 160 degrees. In some embodiments, the direction of each unidirectional monolayer is rotated with respect to the direction in the other unidirectional monolayer at an angle between 70 to 110 degrees. In some embodiments, the direction of each unidirectional monolayer being rotated with respect to the direction in the other unidirectional monolayer at an angle of substantially 90 degrees.

In some embodiments, the direction of the at least one spacer being rotated at an angle with respect to each of said unidirectional monolayers. In some embodiments, the direction of the at least one spacer being rotated with respect to said one unidirectional monolayer at an angle between 10 to 80 degrees.

In some embodiments, said spacer is attached to an external surface of one of said unidirectional monolayers and is covering a portion thereof wherein said portion is less than 50% of said external surface.

In some embodiments, the at least one unidirectional spacer comprises a plurality of unidirectional spacers having a gap between one another. In some embodiments, the at least one spacer is 10-120 micrometer thick.

In some embodiments, the polymer fibers are selected from the group consisting of ultra-high molecular weight polyethylene fiber, aramid fibers and a combination thereof.

In some embodiments, there is provided an impact resistant flexible article comprising a plurality of layers laid upon each other, wherein at least one layer comprises the impact resistant flexible material disclosed herein.

In some embodiments each layer of the article comprises the impact resistant flexible material disclosed above, such that each layer is laid upon the at least one spacer of a consecutive layer, thereby forming interlayer space between consecutive layers within said article.

In some embodiments, the impact resistant flexible article further comprises at least one bilayered fabric comprising unidirectional monolayers each comprising polymer fibers, with the direction of each monolayer being rotated at an angle with respect to the direction in the other unidirectional monolayer. In some embodiments, the at least one spacer, of the at least one impact resistant flexible material, faces the at least one bilayered fabric, thereby forming interlayer space between the at least one impact resistant flexible material and the at least one bilayered fabric.

In some embodiments, the impact resistant flexible article comprises a plurality of impact resistant flexible materials and a plurality of bilayered fabrics.

In some embodiments, the impact resistant flexible article comprises a plurality of impact resistant flexible materials and a plurality of bilayered fabrics, wherein the at least one spacer of each impact resistant flexible material faces one of said plurality of bilayered fabrics. In some embodiments, the direction of each monolayer in said bilayered fabric and in said impact resistant flexible material being rotated at an angle with respect to the direction in an adjacent monolayer.

In some embodiments, the direction of each monolayer in said bilayered fabric and in said impact resistant flexible material being rotated at the following angles with respect to one another: 0°, 75°-100°, 30°-50° and 110°-160°. In some embodiments, the direction of each monolayer in said bilayered fabric and in said impact resistant flexible material being rotated at the following angles with respect to one another: 0°, 80°-95°, 35°-50° and 120°-150°. In some embodiments, the direction of each monolayer in said bilayered fabric and in said impact resistant flexible material being rotated at the following angles with respect to one another: 0°, about 90°, about 45° and about 135°.

In some embodiments, said plurality of layers in the article are attached at the perimeter of one another.

In some embodiments, the impact resistant flexible article comprises at least four bilayered fabrics and at least four impact resistant materials.

In some embodiments, there is provided a supporting structure for being worn on a body part containing the impact resistant flexible material disclosed herein.

In some embodiments, the supporting structure is a body garment.

In some embodiments, there is provided a method for the preparation of the impact resistant flexible article as disclosed herein, the method comprising:
providing layers, comprising:
   a plurality of bilayered fabrics comprising unidirectional monolayers each comprising polymer fibers, with the direction of each monolayer being rotated at an angle with respect to the direction in the other unidirectional monolayer;
   and a plurality of layers comprising the impact resistant flexible material disclosed herein.
laying said layers upon each other, such that the at least one spacer of each impact resistant flexible material faces one of said plurality of bilayered fabrics, thereby forming interlayer spaces between the plurality of impact resistant flexible materials and the plurality of bilayered fabrics, wherein each monolayer in the plurality of bilayered fabrics and in said plurality of impact resistant flexible materials is rotated at an angle with respect to the direction in an adjacent monolayer.

wherein said preparation is essentially devoid use of resins, adhesives or bonding matrices.

In some embodiments, the method further comprises the step of: cutting the multilayered material to a desired shape.

In some embodiments, there is provided a use of the impact resistant flexible article disclosed herein for blocking an impact.

### BRIEF DESCRIPTION OF THE DRAWINGS

Examples illustrative of embodiments are described below with reference to figures attached hereto. In the figures, identical structures, elements or parts that appear in more than one figure are generally labeled with a same numeral in all the figures in which they appear. Alternatively, elements or parts that appear in more than one figure may be labeled with different numerals in the different figures in which they appear. Dimensions of components and features shown in the figures are generally chosen for convenience and clarity of presentation and are not necessarily shown in scale. The figures are listed below.

FIG. 1 schematically illustrates a side view of an impact resistant flexible material, according to some embodiments;

FIG. 2 is a photo of a top view of an impact resistant flexible material, according to some embodiments;

FIG. 3 schematically illustrates a side view of an impact resistant flexible article (“MIT”), according to some embodiments;

FIG. 4 schematically illustrates a side view of an impact resistant flexible article, according to some embodiments;

FIG. 5 schematically illustrates a side view of an impact resistant flexible article, according to some embodiments;

FIG. 6 schematically illustrates a side view of an impact resistant flexible article, according to some embodiments;

FIG. 7 schematically illustrates a side view of an impact resistant flexible article, according to some embodiments;

FIG. 8 schematically illustrates a side view of an impact resistant flexible article, according to some embodiments;

FIG. 9 schematically illustrates a side view of an impact resistant flexible material, according to some embodiments;

FIG. 10 schematically illustrates a side view of an impact resistant flexible material, according to some embodiments;

FIG. 11 is a photo of an impact resistant flexible article, according to some embodiments;

FIG. 12 is a photo demonstrating the resistance to a spike exerted by an impact resistant flexible article, according to some embodiments;

### DETAILED DESCRIPTION OF THE INVENTION

The present invention relates to an impact resistant flexible material, articles made therefrom and preparation thereof. The material comprises a bilayered fabric comprising two adjacent unidirectional monolayers each comprising polymer fibers, with the direction of each unidirectional monolayer being rotated at an angle with respect to the direction in the other unidirectional monolayer; and at least one unidirectional spacer comprising polymer fibers, said spacer is attached to an external surface of one of said unidirectional monolayers and is covering a portion thereof. The article is made of a stack of layers of impact resistant flexible material alone or in combination with other impact resistant polymeric bilayers, such that, the layers are laid upon one another in the absence of any kind of bonding matrices.

Ballistic resistant polymer monolayers are typically formed from fibers, a solution or a powder of the polymer. Polymer fibers are woven, knitted or not woven and monolayers composed from these fibers typically comprise an elastic resin or a polymeric matrix that encapsulate and holds the fibers together (e.g., U.S. Pat. Nos. 4,574,105; 4,820,568 and 4,944,974 among others).

The impact resistant material of disclosed herein is exceptionally flexible, highly impenetrable and particularly light. Without being bound by any theory or mechanism, the advantageous flexibility and softness rendered by the materials and articles disclosed herein are attributed by the spacers and gaps in each material which form multiple air cushions within the articles made therefrom.

In some embodiments, there is provided an impact resistant flexible material, comprising
a bilayered fabric comprising two adjacent unidirectional monolayers each comprising polymer fibers, with the direction of each unidirectional monolayer being rotated at an angle with respect to the direction in the other unidirectional monolayer; and
at least one unidirectional spacer comprising polymer fibers, said spacer is attached to an external surface of one of said unidirectional monolayers and is covering a portion thereof.

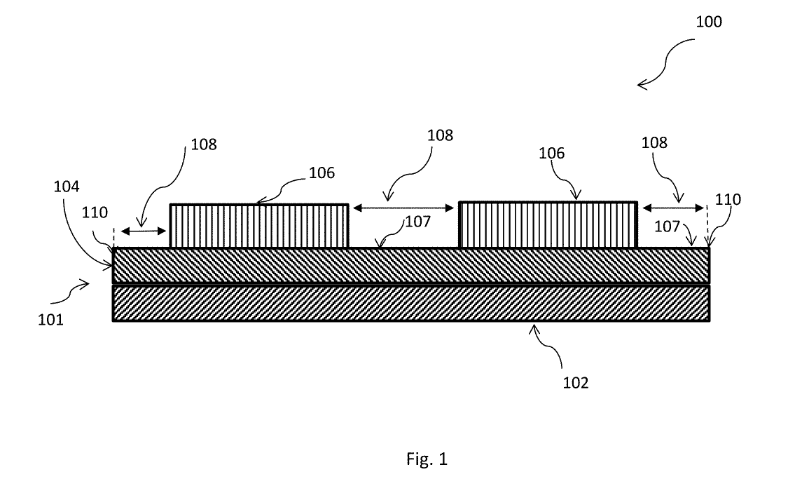

Reference is now made to FIG. 1, which schematically illustrates an impact resistant flexible material 100, according to some embodiments, comprising a bilayered fabric 101 comprising two adjacent unidirectional monolayers 102 and 104 each comprising polymer fibers, with the direction of each unidirectional monolayer being rotated at an angle with respect to the direction in the other unidirectional monolayer and two unidirectional spacers 106 comprising polymer fibers, according to some embodiments, said spacers are attached to an external surface 107 of one of said unidirectional monolayers, each covering a portion thereof, thereby leaving gaps 108 on surface 107 between one spacer 106 to another spacer 106 and, optionally, between a spacer 106 and the perimeters 110 of the material.

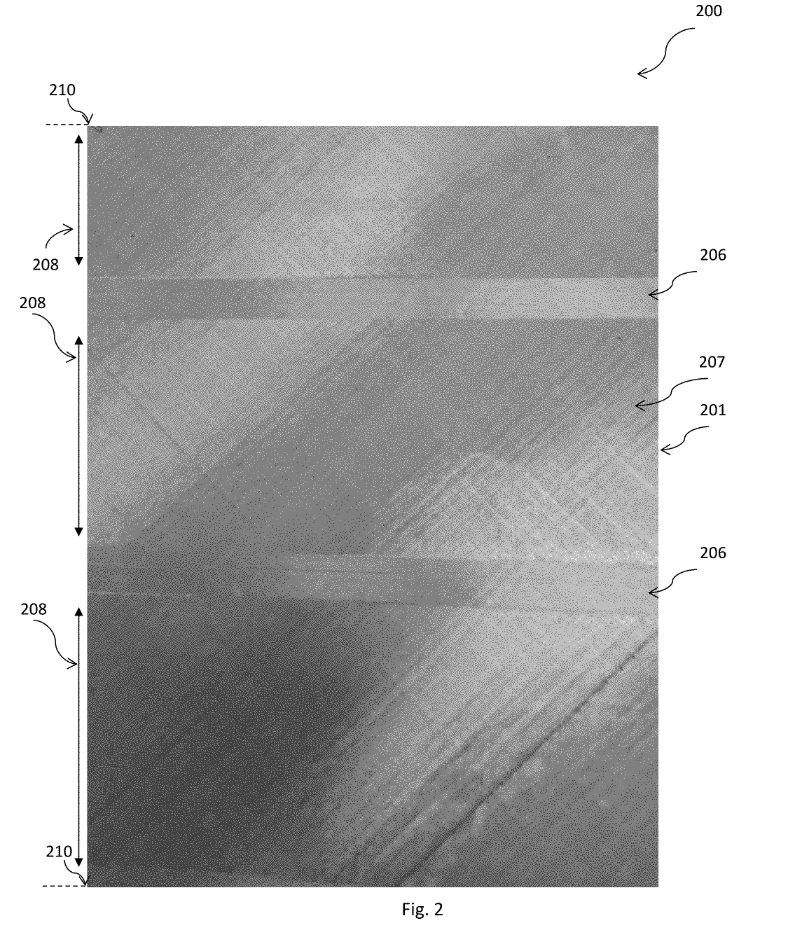

Reference is now made to FIG. 2, which is a photo of an impact resistant flexible material 200, according to some embodiments, comprising a bilayered fabric 201 and two unidirectional spacers 206 where the spacers are attached to an external surface 207 of one of said unidirectional monolayers and are covering a portion thereof, thereby leaving gaps 208 on surface 207 between one spacer 206 to another and between a spacer 106 and the perimeters 210 of the material.

The term “external surface” as used herein refers to the surface of a unidirectional monolayer within the impact resistance material, said surface is facing the at least one spacer. The same unidirectional monolayer has another surface, which may be referred to as an internal surface, which is facing the other unidirectional monolayer in the bilayered fabric. In this context, each unidirectional monolayer is treated as being a material of two dimensions.

In some embodiments, said portion is less than 70% of said external surface. In some embodiments said portion is less than 60% of said external surface. In some embodiments said portion is less than 50% of said external surface. In some embodiments said portion is less than 40% of said external surface. In some embodiments said portion is less than 30% of said external surface. In some embodiments said portion is less than 20% of said external surface.

In some embodiments, said at least one unidirectional spacer is 10-120 μm thick. In some embodiments, said at least one unidirectional spacer is 20-100 μm thick.

In some embodiments, the direction of each unidirectional monolayer is rotated with respect to the direction in the other unidirectional monolayer at an angle between 20 to 160 degrees, 30 to 150 degrees, 40 to 140 degrees or 50 to 130 degrees.

In some embodiments, the direction of each unidirectional monolayer is rotated with respect to the direction in the other unidirectional monolayer at an angle between 60 to 120 degrees or 70 to 110 degrees.

In some embodiments, the direction of each unidirectional monolayer is rotated with respect to the direction in the other unidirectional monolayer at an angle between 80 to 100 degrees or about 90 degrees.

In some embodiments the direction of each unidirectional monolayer being rotated with respect to the direction in the other unidirectional monolayer at an angle of substantially 90 degrees.

In some embodiments, the direction of the at least one unidirectional spacer being rotated at an angle with respect to each of said unidirectional monolayers.

In some embodiments, the direction of the at least one unidirectional spacer is being rotated with respect to said one unidirectional monolayer at an angle between 10 to 80 degrees, between 20 to 70 degrees, between 30 to 60 degrees.

In some embodiments, the direction of the at least one unidirectional spacer is being rotated with respect to said one unidirectional monolayer at an angle between 40 to 50 degrees.

In some embodiments, the direction of the at least one spacer is being rotated with respect to said one unidirectional monolayer at an angle of about 45 degrees.

In some embodiments, said polymer fibers are selected from the group consisting of ultra-high molecular weight polyethylene fiber, aramid fibers, polyamide fibers, fiberglass fibers and a combination thereof.

In some embodiments, said polymer fibers comprise a thermoplastic polymer.

In some embodiments, said polymer fibers comprise polyamide fibers. In some embodiments said polymer fibers are selected from the group consisting of aramid fibers, polyamide-4,6 fibers, polyamide-6,6 fibers, semi-aromatic polyamide fibers and a combination thereof. In some embodiments, said polymer fibers comprise aramid fibers. In some embodiments, said polymer fibers consist of polyamide fibers. In some embodiments, said polymer fibers consist of aramid fibers.

In some embodiments, said polymer fibers comprise a polymer having a weight average molecular mass MW (molecular weight) of about 50,000 g/mol.

In some embodiments said polymer fibers are woven.

In some embodiments, the unidirectional monolayers and the at least one unidirectional spacer comprise substantially the same polymer fibers. In some embodiments the unidirectional monolayers and the at least one unidirectional spacer comprise different polymer fibers.

In some embodiments, at least one of the unidirectional monolayers is having a thickness of about 10-120 μm. In some embodiments, each one of the unidirectional monolayers is having a thickness of about 10-120 μm.

In some embodiments, at least one of the unidirectional monolayers is having an areal density of 20 to 200 g/m². In some embodiments, each one of the unidirectional monolayers is having an areal density of 25 to 200 g/m² in the absence or presence of a bonding matrix.

In some embodiments, at least one of the unidirectional monolayers is having an elongation modulus of 2-6%. In some embodiments, each one of the unidirectional monolayers is having an elongation modulus of 2-6%.

In some embodiments, at least one of the unidirectional monolayers is having an elastic modulus of 400 to 1,700 cN/dTex. In some embodiments, each one of the unidirectional monolayers is having an elastic modulus of 400 to 1,700 cN/dTex.

In some embodiments, at least one of the unidirectional monolayers is having a tensile strength within the range of 8-70 cN/dTex. In some embodiments, at least one of the unidirectional monolayers is having a tensile strength within the range of 20-60 cN/dTex. In some embodiments, at least one of the unidirectional monolayers is having a tensile strength within the range of 50-60 cN/dTex. In some embodiments, each one of the unidirectional monolayers is having a tensile strength within the range of 8-70 cN/dTex.

In some embodiments, the bilayered fabric comprises a binder (resin/matrix).

In some embodiments, the at least one unidirectional spacer is attached to the external surface of the unidirectional monolayers using a binder.

In some embodiments, the binder comprises a thermoplastic binder.

In some embodiments, the binder is selected from the group consisting of polyurethanes, polyvinyls, polyacrylics, polyolefins and thermoplastic elastomeric block copolymers, polyisopropene-polyethylene-butylene-polystyrene, polystyrene-polyisoprene-polystyrene block copolymers.

In some embodiments, the binder comprises at most 30% of the total weight of said bilayered fabric. In some embodiments, the binder comprises at most 25% of the total weight of said bilayered fabric. In some embodiments, the binder comprises at most 20% of the total weight of said bilayered fabric. In some embodiments, the binder comprises at most 15% of the total weight of said bilayered fabric. In some embodiments, the binder comprises at most 10% of the total weight of said bilayered fabric.

In some embodiments the bilayered fabric has a tensile strength within the range of 8-70 cN/dTex.

In some embodiments the bilayered fabric has a maximal displacement of 2-12 mm per 200 mm.

In some embodiments, the at least one unidirectional spacer has a thickness of about 1-150 μm. In some embodiments the at least one unidirectional spacer has a thickness of about 1-100 μm. In some embodiments the at least one unidirectional spacer has a thickness of about 10-50 μm.

In some embodiments, the at least one unidirectional spacer has an areal density of about 70-130% in comparison with the areal density of the unidirectional monolayers.

In some embodiments, the at least one unidirectional spacer has an elongation modulus of about 70-130% in comparison with the elongation modulus of the unidirectional monolayers.

In some embodiments, the at least one unidirectional spacer has an elastic modulus of about 70-130% in comparison with the elastic modulus of the unidirectional monolayers.

In some embodiments, the at least one unidirectional spacer has a tensile strength of about 70-130% in comparison with the tensile strength of the unidirectional monolayers.

In some embodiments, the at least one unidirectional spacer has a maximal displacement of about 70-130% in comparison with the maximal displacement of the unidirectional monolayers.

In some embodiments, the at least one unidirectional spacer has an elongation modulus of 2-6%.

In some embodiments the at least one unidirectional spacer has an elastic modulus of 400 to 1,700 cN/dTex.

In some embodiments the at least one unidirectional spacer has a tensile strength within the range of 8-70 cN/dTex.

In some embodiments, the at least one unidirectional spacer has a maximal displacement of 2-12 mm per 200 mm.

In some embodiments, the at least one unidirectional spacer is substantially in a two dimensional geometric shape. In some embodiments, the geometric shape in selected from the group consisting of simple polygons, spherical polygons, abstract polytopes and any combination thereof. In some embodiments, the geometric shape consists of simple polygons. In some embodiments, the polygons are selected from the group consisting of trigons, quadrilaterals, pentagons, hexagons, heptagons, octagons, enneagons, decagons and combinations thereof. In some embodiments, polygons are quadrilaterals. In some embodiments, the quadrilaterals are selected from the group consisting of rhombi, rectangles, rhomboids and squares. In some embodiments, the quadrilaterals are rectangles. In some embodiments, each rectangle comprises a long edge and a short edge. In some embodiments, said long edge is substantially the same length as the unidirectional monolayers. In some embodiments, the short edge is 1-30% of the width of the bilayer.

In some embodiments, the at least one unidirectional spacer comprises a plurality of unidirectional spacers.

In some embodiments, the at least one unidirectional spacer is consisting essentially of a plurality of unidirectional spacers.

In some embodiments, a plurality of unidirectional spacers is also attached to the external surface of the other unidirectional monolayer, thereby forming a bilayer material having a plurality of spacers on each external surface (side) thereof.

The terms “unidirectional” or “unidirectional polymer fibers” are interchangeably used herein to describe polymer films formed by compression-molding and unidirectional stretching of the polymer. The direction of stretching determines the direction of the resulting films. The unidirectional films can be split along the direction of stretching.

In some embodiments, a unidirectional monolayer is prepared by drawing particulate polymeric powder at a temperature lower than the melting point thereof, thereby obtaining a unidirectionally oriented polymer film exhibiting high tensile strength at the direction of stretching.

Typically, drawing comprises the steps of: compression-molding, rolling and stretching. In some embodiments, the polymer films are monolayers drawn as follows:
1. feeding a polymer in a powder form between a combination of endless belts disposed in an up-and-down opposing relation;
2. compression-molding the polymer powder at a temperature lower than the melting point of the polymer powder by pressing means; and
3. rolling the resultant compression-molded polymer, followed by stretching at a single direction, thereby obtaining a unidirectional polymer monolayer.

In some embodiments, there is provided an impact resistant flexible article comprising a plurality of layers laid upon each other, wherein at least one layer comprises an impact resistant flexible material as described herein.

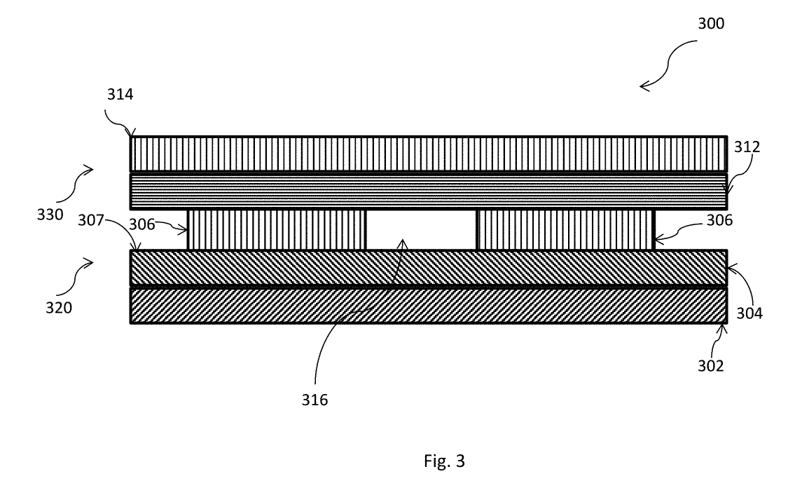

Reference is now made to FIG. 3, which schematically illustrates an impact resistant flexible article 300, according to some embodiments, comprising one layer comprises an impact resistant flexible material 320, according to some embodiments, comprising two adjacent unidirectional monolayers 302 and 304 each comprising polymer fibers, with the direction of each unidirectional monolayer being rotated at an angle with respect to the direction in the other unidirectional monolayer and two unidirectional spacers 306 comprising polymer fibers, according to some embodiments, said spacers are attached to an external surface 307 of one of said unidirectional monolayers and is covering a portion thereof. Impact resistant flexible article 300 also comprises a bilayered fabric 330 comprising unidirectional monolayers 312 and 314 each comprising polymer fibers, with the direction of each monolayer being rotated at an angle with respect to the direction in the other unidirectional monolayer. Impact resistant flexible material 320 and bilayered fabric 330 are laid one on top of the other such that a void 316 (“air cushion”) is formed between the impact resistant flexible material 320 at the bottom, the bilayered fabric 330 at the top, and spacers 306 on the sides.

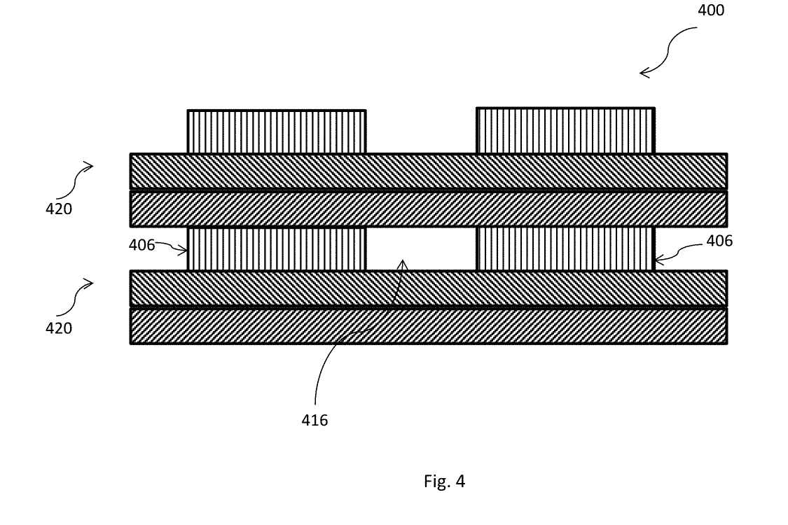

Reference is now made to FIG. 4, which schematically illustrates an impact resistant flexible article 400, according to some embodiments, comprising two impact resistant flexible materials 420, according to some embodiments, laid one on top of the other such that a void 416 (“air cushion”) is formed between the two impact resistant flexible materials 420 and spacers 406.

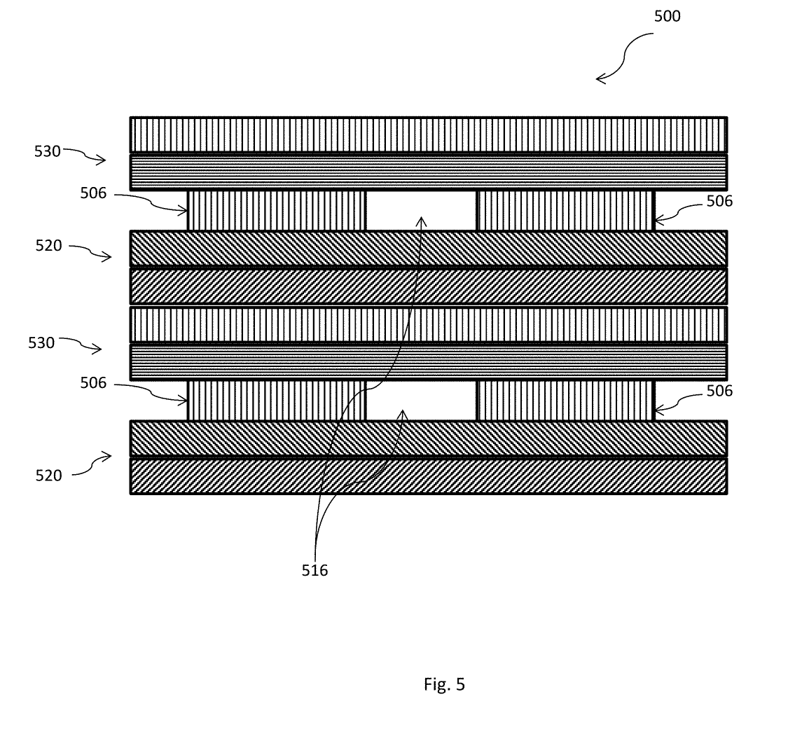

Reference is now made to FIG. 5, which schematically illustrates an impact resistant flexible article 500, according to some embodiments, comprising four layers laid one on top of the other: a first layer of impact resistant flexible materials 520, a second layer of bilayered fabric 530, a third layer of impact resistant flexible materials 520 and a fourth layer of bilayered fabric 530, wherein the spacers 506 of the impact resistant flexible materials face the bilayered fabric layers 530 thereby forming spaces 516 (“air cushions”).

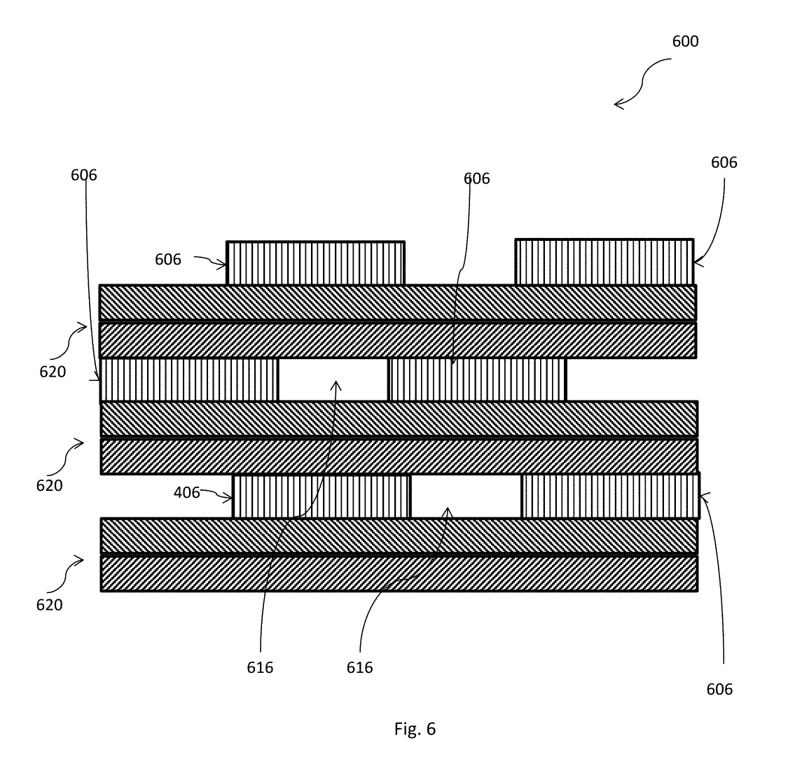

Reference is now made to FIG. 6, which schematically illustrates an impact resistant flexible article 600, according to some embodiments, comprising three impact resistant flexible materials 620 (“Multiple Integrated Technology” or “MIT”), according to some embodiments, laid one on top of the other such that a plurality of voids 616 (“air cushions”) are formed between each two consecutive impact resistant flexible materials 620 and spacers 606, and such that the spacers 606 of each impact resistant flexible materials 620, are shifted with respect to the spacers 606 of the following impact resistant flexible materials 620, thereby creating non-overlying plurality of voids 616.

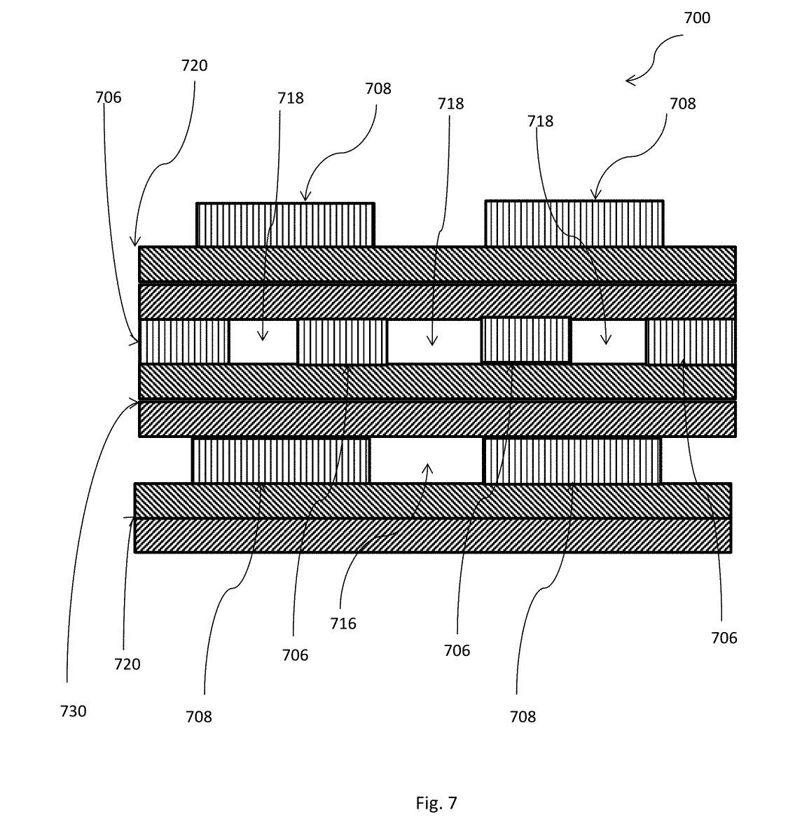

Reference is now made to FIG. 7, which schematically illustrates an impact resistant flexible article 700, according to some embodiments, comprising first impact resistant flexible materials 720, and a second first impact resistant flexible material 730, according to some embodiments. Material 730 includes spacers 706, and is laid between materials 720, which include spacers 708, wherein spacers 706 have different dimensions than spacers 708, such that there is formed a void 716 between spacers 708 and material 730, in addition to voids 718 between spacers 706 and materials 720, wherein also void 716 has different dimensions than those of voids 718.

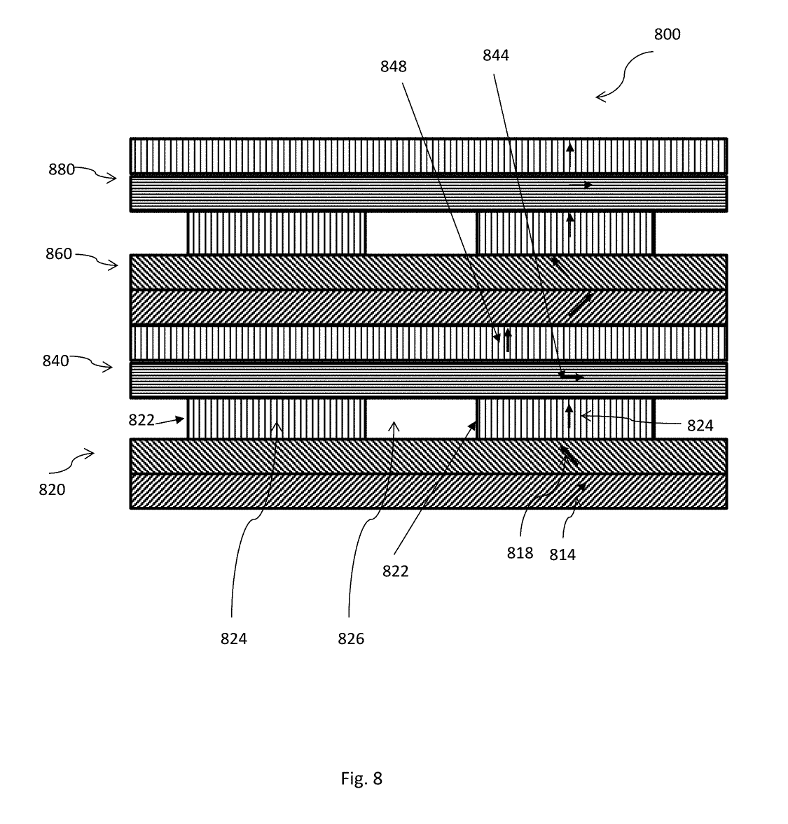

Reference is now made to FIG. 8, which schematically illustrates an impact resistant flexible article 800, according to some embodiments, comprising four layers laid one on top of the other: a first layer is an impact resistant flexible material 820, a second layer is a bilayered fabric 840, a third layer is an additional impact resistant flexible materials 860 and a fourth layer is an additional bilayered fabric 880. The directions 814 and 818 of the unidirectional monolayers within the first layer 820 are 45/135°, respectively. Spacers 822 of material 820 are unidirectional, at an angle 824 of 90° with respect to the surface of material 810. Spacers 822 face bilayered fabric 840, thereby forming void 826 (“air cushion”), between spacers 822 and bilayered fabric 840. The directions 844 and 848 of the unidirectional monolayers within the second layer 840 are 0/90°, respectively. The directions of the unidirectional monolayers within the third 860 and fourth 880 layers are also 45/135° and 0/90°, respectively

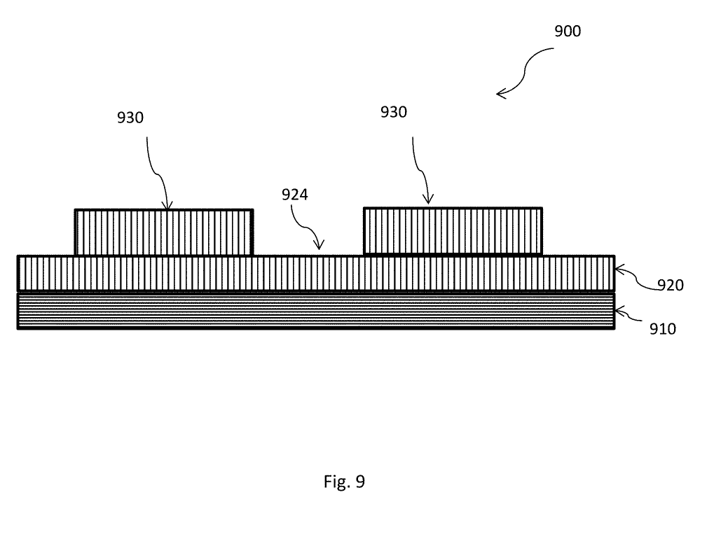

Reference is now made to FIG. 9, which schematically illustrates an impact resistant flexible material 900, where the direction of the unidirectional monolayers 910 and 920 is 0/90°. The direction of the unidirectional spacers 930 is 90° with respect to the surface 924 of material 900.

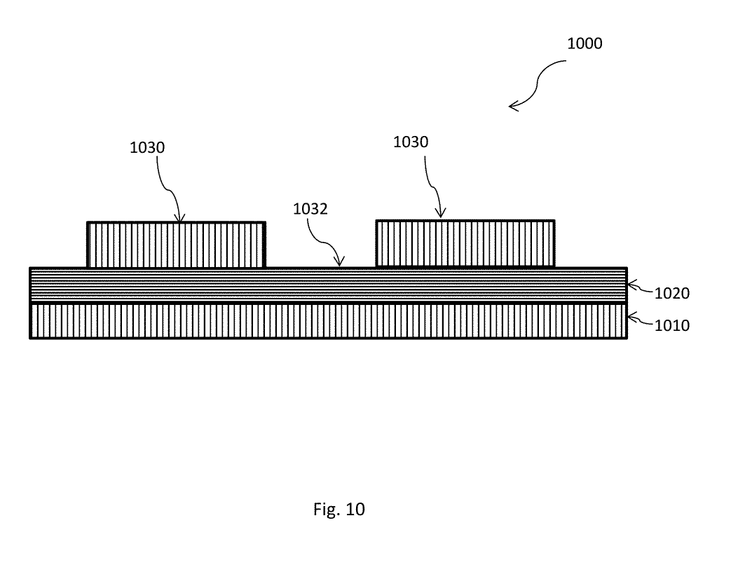

Reference is now made to FIG. 10, which schematically illustrates an impact resistant flexible material 1000. Material 1000 consists of unidirectional monolayers 1010 and 1020 where the directions of the monolayers are 0/90° with respect to one another. The direction of spacers 1030 is 90° with respect to the surface 1032 of material 1000.

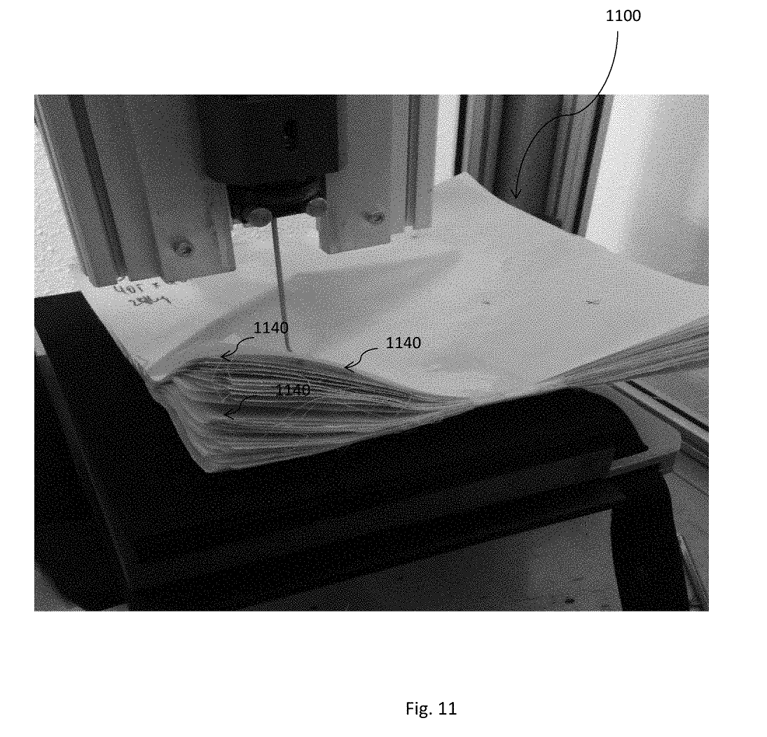

Reference is now made to FIG. 11, which is a photo of an impact resistant flexible article 1100 made of a stack of layers 1140 laid one on top of the other, which are not glued, affixed, pasted or otherwise attached to one another by any kind of bonding matrices, resins and the like.

In some embodiments, each layer comprises an impact resistant flexible material as described herein, such that each layer is laid upon the at least one spacer of a consecutive layer, thereby forming interlayer space between consecutive layers.

In some embodiments, the direction of each monolayer is rotated at an angle with respect to the direction in the consecutive unidirectional monolayer.

In some embodiments, the at least one bilayered fabric comprises unidirectional monolayers each comprising polymer fibers, with the direction of each monolayer being rotated at an angle with respect to the direction in the other unidirectional monolayer.

In some embodiments, the angle is between 20 and 160 degrees. In some embodiments the angle is between 40 and 140 degrees. In some embodiments, the angle is between 60 and 120 degrees. In some embodiments, the angle is between 80 and 100 degrees. In some embodiments, the angle is about 90 degrees.

In some embodiments, the at least one spacer of the at least one impact resistant flexible material faces the at least one bilayered fabric, thereby forming an interlayer space (also termed herein “cushion” or “air cushion”) between the at least one impact resistant flexible material and the at least one bilayered fabric.

In some embodiments, the impact resistant flexible article comprises a plurality of impact resistant flexible materials and a plurality of bilayered fabrics.

In some embodiments, the impact resistant flexible article comprises a plurality of impact resistant flexible materials and a plurality of bilayered fabrics, such that the at least one spacer of each impact resistant flexible material faces one of said plurality of bilayered fabrics.

In some embodiments, the direction of each monolayer in said bilayered fabric and in said impact resistant flexible material being rotated at an angle with respect to the direction in an adjacent monolayer.

In some embodiments, the angle is between 10 and 80 degrees. In some embodiments the angle is between 20 and 70 degrees. In some embodiments, the angle is between 30 and 60 degrees. In some embodiments the angle is between 40 and 50 degrees. In some embodiments the angle is about 45 degrees.

In some embodiments, the plurality of layers comprises at least 3 layers. In some embodiments, the plurality of layers comprises at least 5 layers. In some embodiments, the plurality of layers comprises at least 10 layers. In some embodiments, the plurality of layers comprises at least 15 layers. In some embodiments, the plurality of layers comprises at least 20 layers. In some embodiments, the plurality of layers comprises 2 to 100 layers. In some embodiments, the plurality of layers comprises 2 to 75 layers. In some embodiments, the plurality of layers comprises 2 to 50 layers. In some embodiments, the plurality of layers comprises 4 to 40 layers. In some embodiments, the plurality of layers comprises 6 to 36 layers. In some embodiments, the plurality of layers comprises 10 to 30 layers. In some embodiments, the plurality of layers comprises 20 to 30 layers.

In some embodiments, the plurality of impact resistant flexible materials comprises at least 3 impact resistant flexible materials. In some embodiments, the plurality of impact resistant flexible materials comprises at least 5 impact resistant flexible materials. In some embodiments, the plurality of impact resistant flexible materials comprises at least 10 impact resistant flexible materials. In some embodiments, the plurality of impact resistant flexible materials comprises at least 15 impact resistant flexible materials. In some embodiments, the plurality of impact resistant flexible materials comprises at least 20 impact resistant flexible materials. In some embodiments, the plurality of impact resistant flexible materials comprises 2 to 100 impact resistant flexible materials. In some embodiments, the plurality of impact resistant flexible materials comprises 2 to 75 impact resistant flexible materials. In some embodiments, the plurality of impact resistant flexible materials comprises 2 to 50 impact resistant flexible materials. In some embodiments, the plurality of impact resistant flexible materials comprises 4 to 40 impact resistant flexible materials. In some embodiments, the plurality of impact resistant flexible materials comprises 6 to 36 impact resistant flexible materials. In some embodiments, the plurality of impact resistant flexible materials comprises 10 to 30 impact resistant flexible materials. In some embodiments, the plurality of impact resistant flexible materials comprises 20 to 30 impact resistant flexible materials.

In some embodiments, the plurality of bilayered fabrics comprises at least 3 bilayered fabrics. In some embodiments, the plurality of bilayered fabrics comprises at least 5 bilayered fabrics. In some embodiments, the plurality of bilayered fabrics comprises at least 10 bilayered fabrics. In some embodiments, the plurality of bilayered fabrics comprises at least 15 bilayered fabrics. In some embodiments, the plurality of bilayered fabrics comprises at least 20 bilayered fabrics. In some embodiments, the plurality of bilayered fabrics comprises 2 to 100 bilayered fabrics. In some embodiments, the plurality of bilayered fabrics comprises 2 to 75 bilayered fabrics. In some embodiments, the plurality of bilayered fabrics comprises 2 to 50 bilayered fabrics. In some embodiments, the plurality of bilayered fabrics comprises 4 to 40 bilayered fabrics. In some embodiments, the plurality of bilayered fabrics comprises 6 to 36 bilayered fabrics. In some embodiments, the plurality of bilayered fabrics comprises 10 to 30 bilayered fabrics. In some embodiments, the plurality of bilayered fabrics comprises 20 to 30 bilayered fabrics.

In some embodiments, the interlayer space is having a volume of more than 10 μm³.

It is to be understood that the term “space” as used herein refers to a void, substantially absent of any of the components of the articles, including any polymeric materials, solvents, resins and the like.

The terms “laid upon” or “laid upon each other” as used herein are interchangeable and describe two objects, typically two dimensional objects, such as layers or spacers, which are placed over one another in the absence of any attachment, let alone any irreversible attachment, between said objects' surfaces. For example, two consecutive layers of the current invention may be laid upon one another, such that the layers are not integrated with one another. In particular, a layer of the current invention may be placed over a consecutive layer, such that one layer is laid upon the spacer of said consecutive layer, whereas the layer does not adhere, or otherwise glued, to the spacer of said consecutive layer. In contrast, the two unidirectional monolayers constructing the bilayered fabric may be irreversibly connected to one another, for example using a binder, a resin or another adhesive material. Without derogating the aforesaid, the terms “laid upon” or “laid upon each other” are not intended to restrict the option of coupling two consecutive layers by securing small portions of their surfaces to one another. For example, two layers may be stitched to one another at their perimeters, such that an empty space remains over major parts of their surfaces.

In some embodiments, said plurality of layers are attached at the perimeter of one another.

In some embodiments, said attaching at the perimeter comprises stitching.

The present invention is based in part on the unexpected discovery that articles comprising a plurality of layers laid upon each other, wherein at least one layer comprises an impact resistant flexible material as described above, present improved features, such as enhanced flexibility and improved impact resistance.

The materials and articles of the present invention are particularly advantageous over previously known anti stabbing materials as they provide the following features:
1. Low weight—the impact resistant flexible material of the present invention afford the manufacturing of stabbing resistant molded articles that provide better level of protection compared to known molded articles at a significantly lower weight. Perhaps the most influential factor in weight decrease is the spaces, or ‘air cushions’, found between layers of the present invention. Low weight per unit area is of great importance in many applications. This is the case, for instance, in the field of personal protective wearable equipment, such as, vests, coats, collars and the like.
2. Economical—the avoidance from using an adhesive or a resin between the layers as well as utilization of ‘air cushions’ as part of the protective article, reduces the expenditure involved in preparing the materials and articles, thereby providing a cost-effective article as compared with anti-stabbing articles known in the art;
3. Deformation resistance—due to the reduced use of resins and other bonding materials the articles maintain their structure even under an extreme impact, such as, high levels of impact as defined by international standards (e.g. NIJ US, HOSDB UK and Technische Richtlinie, DE); and

In some embodiments, there is provided supporting structure for being worn on a body part containing an impact resistant flexible article as described herein.

In some embodiments, the supporting structure is a body garment.

In some embodiments, the body garment in selected from the group consisting of a jacket, a coat, a shirt, a vest, such as but not limited to a protective vest, a sweater or a collar.

In some embodiments, there is provided a method for the preparation of an impact resistant flexible article comprising:
providing a plurality of layers, comprising
   a plurality of bilayered fabrics comprising unidirectional monolayers each comprising polymer fibers, with the direction of each monolayer being rotated at an angle with respect to the direction in the other unidirectional monolayer;
   and a plurality of layers comprising impact resistant flexible materials as described herein.
laying said plurality of layers upon each other, such that the at least one spacer of each impact resistant flexible material faces one of said plurality of bilayered fabrics, thereby forming interlayer spaces between the plurality of impact resistant flexible materials and plurality of bilayered fabrics, wherein each monolayer in plurality of bilayered fabrics and in said plurality of impact resistant flexible materials is rotated at an angle with respect to the direction in an adjacent monolayer.

wherein said preparation is essentially devoid use of resins, adhesives, bonding matrices or the like.

In some embodiments, the method further comprises the step of: cutting the multilayered material to a desired shape.

In some embodiments, the method further comprising attaching the layers to one another one or more regions at their perimeters, to avoid the sliding of layers away from the structure of the article.

In some embodiments, there is provided a use of an impact resistant flexible article as disclosed herein for blocking impact. In some embodiments, the impact is produced by a sharp object. In some embodiments, said sharp objects comprise blades and spikes.

In some embodiments, said impact resistant flexible article comprises at least two layers, at least four layers, at least six layers, at least eight layers, or at least 10 layers. In some embodiments, said impact resistant flexible article comprises at least a dozen of layers. In some embodiments, said impact resistant flexible article comprises at least 15 layers. In some embodiments, said impact resistant flexible article comprises at least 19 layers. In some embodiments, said impact resistant flexible article comprises at least 20 layers. In some embodiments, said impact resistant flexible article comprises at least 21 layers. In some embodiments, said impact resistant flexible article comprises between 10 and 40 layers. In some embodiments, said impact resistant flexible article comprises between 15 and 30 layers. In some embodiments, said impact resistant flexible article comprises between 18 and 27 layers.

### EXAMPLES

### Example 1

### Impact Resistance Tests

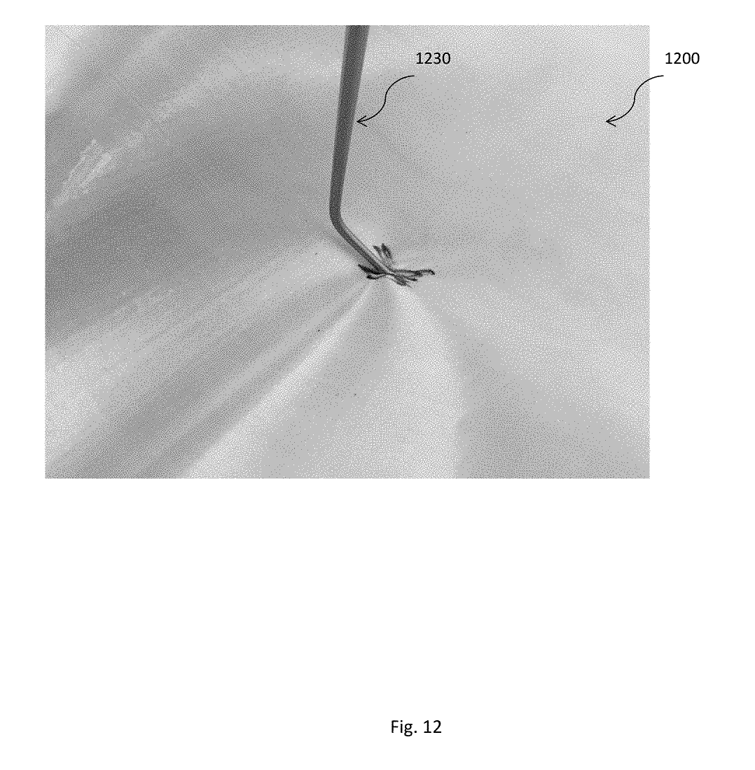

Impact resistance test were conducted in accordance to international standards (Table 1). In brief, multilayers articles made of a number of basic MIT units, each MIT unit is consisting of the impact resistant flexible material (bilayer and spacer(s)) and the bilayer fabric (altogether four unidirectional monolayer and spacer(s)), were subjected to stabbing and puncturing, as shown, for example, in FIG. 12. The table includes results obtained from various threats (blades, spikes and ballistics). Most of the articles tested were 100% MIT (as shown by the term X ly—MIT, in the column entitled “No. of Layers (1y)”). However, for resisting ballistics the multilayered structure was combined with soft ballistic (SB) material, in a ratio of at least 90% MIT and the remaining (at most 10%) SB (see articles termed X ly—MIT . . . -Soft Ballistic” in the column entitled “No. of Layers (1y)”). The results indicate that spikes merely pierced a couple of the top layers and then bent (FIG. 12). This performance was surprising especially in view of the fact that spikes easily pierced through the entire thickness of other polymeric articles of similar dimensions (results not shown).

TABLE 1
Impact resistance test results

| | | | Weight² | No. of MIT |
|---|---|---|---|---|
| Standard | Level | Threat | (kg/m²) | Layers¹ (ly) |
| NIJ 0115.00, USA | Level 1 (E1 + E2) | Blades P1/A + S1 | 4.35 | 19 ly - MIT |
| | Level 1 (E1 + E2) | Blades P1/A + S1 + Spike | 4.8 | 21 ly - MIT |
| | Level 2 (E1 + E2) | Blades P1/A + S1 | 4.8 | 21 ly - MIT |
| | Level 2 (E1 + E2) | Blades P1/A + S1 + Spike | 5.27 | 23 ly - MIT |
| | Level 3 (E1 + E2) | Blades P1/A + S1 | 5.5 | 24 ly - MIT |
| | Level 3 (E1 + E2) | Blades P1/A + S1 + Spike | 5.72 | 25 ly - MIT |
| HOSDB Body Armor | KR1(E1 + E2) + | Blade P1/B + Spike SP/B | 4.35 | 19 ly - MIT |
| 2007, UK | SP1 (E1) | | | |
| | KR2 (E1 + E2) + | Blade P1/B + Spike SP/B | 4.8 | 21 ly - MIT |
| | SP2 (E1) | | | |
| | KR3 (E1 + E2) + | Blade P1/B + Spike SP/B | 5.5 | 24 ly - MIT |
| | SP3 (E1) | | | |
| Technische Richtlinie | | All threat | 4.35 | 19 ly - MIT |
| April 2003, GERMANY | | | | |
| Technische Richtlinie | | All threat | 4.35 | 19 ly - MIT |
| March 2008, GERMANY | | | | |
| VPAM May 2009 | K1/D1 | All threat | 4.12 | 18 ly - MIT |
| | K2/D2 | All threat | 4.35 | 19 ly - MIT |
| | K3/D3 | All threat | 5.5 | 24 ly - MIT |
| | K4/D4 | All threat | 5.72 | 25 ly - MIT |
| ^{§}NIJ 0101.06/.04, USA | II | 9 mm | 4.35 | 19 ly - MIT |
| NIJ 0115.00, USA | Level 1 (E1 + E2) | Blades P1/A + S1 | | |
| HOSDB Body Armor | KR1(E1 + E2) + | Blade P1/B + Spike SP/B | | |
| 2007, UK | SP1 (E1) | | | |
| ^{§}NIJ 0101.06/.04, USA | II | 9 mm + .357 Mag | 5.3 (4.8 + 0.5) | 21 ly - MIT + |
| | | | | 0.5 kg/m2 - |
| | | | | Soft Ballistic |
| NIJ 0115.00, USA | Level 2 (E1 + E2) | Blades P1/A + S1 | | |
| HOSDB Body Armor | KR2 (E1 + E2) + | Blade P1/B + Spike SP/B | | |
| 2007, UK | SP2 (E1) | | | |
| ^{§}NIJ 0101.04, USA | IIIA | 9 mm | 4.8 | 21 ly - MIT |
| NIJ 0115.00, USA | Level 1 (E1 + E2) | Blades P1/A + S1 + Spike | | |
| NIJ 0115.00, USA | Level 2 (E1 + E2) | Blades P1/A + S1 | | |
| HOSDB Body Armor | KR2(E1 + E2) + | Blade P1/B + Spike SP/B | | |
| 2007, UK | SP2 (E1) | | | |
| ^{§}NIJ 0101.06, USA | IIIA | .357 SIG | 5.990 (5.27 + 0.72) | 23 ly - MIT + |
| | | | | 0.72 kg/m2 - |
| | | | | Soft Ballistic |
| NIJ 0115.00, USA | Level 2 (E1 + E2) | Blades P1/A + S1 + Spike | | |
| HOSDB Body Armor | KR2 (E1 + E2) + | Blade P1/B + Spike SP/B | | |
| 2007, UK | SP2 (E1) | | | |
| ^{§}NIJ 0101.06, USA | IIIA | .357 SIG + .44 Mag | 6.440 (5.72 + 0.72) | 25 ly - MIT + |
| | | | | 0.72 kg/m2 - |
| | | | | Soft Ballistic |
| NIJ 0115.00, USA | Level 3 (E1 + E2) | Blades P1/A + S1 + Spike | | |
| HOSDB Body Armor | KR3 (E1 + E2) + | Blade P1/B + Spike SP/B | | |
| 2007, UK | SP3 (E1) | | | |

¹Each multilayer comprises (A) an impact resistant flexible material and (B) a bilayered fabric, where each multilayer weighs about 229 g/m².
²Also termed ‘aerial density’ or AD, per each multilayer.
^{§}Ballistic protection

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

What is claimed is:

1. An impact resistant flexible material, comprising
a bilayered fabric comprising two adjacent unidirectional monolayers each comprising polymer fibers, with the direction of each unidirectional monolayer being rotated at an angle with respect to the direction in the other unidirectional monolayer; and
at least one unidirectional spacer comprising polymer fibers, said spacer is attached to an external surface of one of said unidirectional monolayers and is covering a portion thereof.

2. The impact resistant flexible material of claim 1, wherein the direction of each unidirectional monolayer is rotated with respect to the direction in the other unidirectional monolayer at an angle between 20 to 160 degrees.

3. (canceled)

4. The impact resistant flexible material of claim 2, wherein the direction of each unidirectional monolayer being rotated with respect to the direction in the other unidirectional monolayer at an angle of substantially 90 degrees.

5. The impact resistant flexible material of claim 1, wherein the direction of the at least one spacer being rotated at an angle with respect to each of said unidirectional monolayers.

6. (canceled)

7. The impact resistant flexible material of claim 1, wherein said portion is less than 50% of said external surface.

8. The impact resistant flexible material of claim 7, wherein the at least one unidirectional spacer comprises a plurality of unidirectional spacers having a gap between one another.

9. The impact resistant flexible material of claim 1, wherein said at least one spacer is 10-120 μm thick.

10. The impact resistant flexible material of claim 1, wherein said polymer fibers are selected from the group consisting of ultra-high molecular weight polyethylene fiber, aramid fibers and a combination thereof.

11. An impact resistant flexible article comprising a plurality of layers laid upon each other, wherein at least one layer comprises the impact resistant flexible material of claim 1.

12. The impact resistant flexible article of claim 11, wherein each layer is laid upon the at least one spacer of a consecutive layer, thereby forming interlayer space between consecutive layers.

13. The impact resistant flexible article of claim 11, comprising at least one bilayered fabric comprising unidirectional monolayers each comprising polymer fibers, with the direction of each monolayer being rotated at an angle with respect to the direction in the other unidirectional monolayer.

14. The impact resistant flexible article of claim 13, wherein the at least one spacer of the at least one impact resistant flexible material faces the at least one bilayered fabric, thereby forming interlayer space between the at least one impact resistant flexible material and the at least one bilayered fabric.

15. The impact resistant flexible article of claim 13 comprising a plurality of impact resistant flexible materials and a plurality of bilayered fabrics.

16. The impact resistant flexible article of claim 14 comprising a plurality of impact resistant flexible materials and a plurality of bilayered fabrics, wherein the at least one spacer of each impact resistant flexible material faces one of said plurality of bilayered fabrics.

17. The impact resistant flexible article of claim 13, wherein the direction of each monolayer in said bilayered fabric and in said impact resistant flexible material being rotated at an angle with respect to the direction in an adjacent monolayer.

18. The impact resistant flexible material of claim 11, wherein said plurality of layers are attached at the perimeter of one another.

19. The impact resistant flexible article of claim 18, comprising at least four bilayered fabrics and at least four impact resistant materials.

20. A supporting structure for being worn on a body part containing the impact resistant flexible material of claim 11.

21. (canceled)

22. A method for the preparation of an impact resistant flexible article, comprising:
providing a plurality of layers, comprising
a plurality of bilayered fabrics comprising unidirectional monolayers each comprising polymer fibers, with the direction of each monolayer being rotated at an angle with respect to the direction in the other unidirectional monolayer; and a plurality of layers comprising the impact resistant flexible materials of claim.
laying said plurality of layers upon each other, such that the at least one spacer of each impact resistant flexible material faces one of said plurality of bilayered fabrics, thereby forming interlayer spaces between the plurality of impact resistant flexible materials and plurality of bilayered fabrics, wherein each monolayer in plurality of bilayered fabrics and in said plurality of impact resistant flexible materials is rotated at an angle with respect to the direction in an adjacent monolayer thereby obtaining an impact resistant flexible article,
wherein said preparation is essentially devoid use of resins, adhesives or bonding matrices.

23. (canceled)

24. Use of the impact resistant flexible article of claim 11 for blocking an impact.
